(19) United States
(12) Patent Application Publication
(10) Pub. No.: US 2013/0103346 A1
(43) Pub. Date: Apr. 25, 2013

(54) MEASUREMENT METHOD

(71) Applicant: CANON KABUSHIKI KAISHA, Tokyo (JP)

(72) Inventors: Masaki Hosoda, Cambridge, MA (US); Yasushi Iwasaki, Utsunomiya-shi (JP)

(73) Assignee: CANON KABUSHIKI KAISHA, Tokyo (JP)

(21) Appl. No.: 13/632,566

(22) Filed: Oct. 1, 2012

(30) Foreign Application Priority Data
Oct. 19, 2011 (JP) 2011-229894

(51) Int. Cl. G01B 11/24; G06F 15/00

(52) U.S. Cl. 702/167

(57) ABSTRACT

The present invention provides a measurement method of measuring a shape of a surface to be measured having an outer shape of a regular hexagon, including a first step of setting, on the surface to be measured, a plurality of partial regions having an identical outer shape of a parallelogram to cover the entire surface to be measured, a second step of measuring surface shapes of the respective partial regions by a measurement apparatus to obtain measurement data of the respective partial regions, and a third step of connecting the measurement data of the respective partial regions to calculate the shape of the surface to be measured, wherein the parallelogram has internal angles of 120° and 60°, and a maximum length of one side is not larger than a length of one side of the regular hexagon.

### BACKGROUND OF THE INVENTION

1. Field of the Invention

The present invention relates to a measurement method of measuring the shape of a surface to be measured.

2. Description of the Related Art

Recently, terrestrial telescopes whose primary mirror has a diameter of 30 m or more have been developed. It is difficult to fabricate a primary mirror having a diameter of 30 m or more at once, so the primary mirror is generally formed by combining a plurality of mirrors (segment mirrors). The primary mirror of a large astronomical telescope such as a TMT (Thirty Meter Telescope) or EELT (European Extremely Large Telescope) is formed from hexagonal segment mirrors having an inscribed circle diameter of more than 1 m. Even if the inscribed circle diameter of the segment mirror is about 1 m, it is not practical to measure the entire surface of the segment mirror at once because this increases the cost owing to upsizing of the apparatus and decreases the measurement accuracy.

Under the circumstance, U.S. Pat. No. 6,956,657 discloses a stitch method of dividing a surface to be measured into a plurality of partial regions, measuring their surface shapes, and connecting (stitching) measurement data of the respective partial regions, thereby obtaining the surface shape of the surface to be measured. In U.S. Pat. No. 6,956,657, an interferometer is used to measure (the surface shape of) a partial region, and measurement data is always compared with a reference surface. Hence, this method advantageously has high stitch accuracy.

As for the stitch method, Japanese Patent Laid-Open No. 2009-294134 proposes a technique using a 3D measurement apparatus when measuring a partial region. In Japanese Patent Laid-Open No. 2009-294134, a reference shape is optimized using all measurement data of respective partial regions, and stitching is implemented without using an overlapping region between the partial regions.

In the stitch method, when evaluating (the surface shape of) a partial region for each spatial frequency, a Zernike function is generally used as an orthogonal function. The Zernike function is very useful when evaluating a circular region for each spatial frequency. However, when a circular region is set as a partial region, the partial region extends outside a surface to be measured at the periphery of the surface to be measured, so the partial region does not become circular. Similarly, when a partial region is set for a hexagonal segment mirror, the partial region does not become circular at the periphery of the segment mirror. In this case, the Zernike function cannot be applied as an orthogonal function to each partial region.

In the specification of U.S. Pat. No. 6,956,657, measurement data of respective partial regions are stitched by optimizing measurement data for respective pixels in an overlapping region, and the Zernike function is applied to a circular surface to be measured after stitching. Japanese Patent Laid-Open No. 2009-294134 does not concretely disclose a method of determining a system error using measurement data of partial regions. In U.S. Pat. No. 6,956,657 and Japanese Patent Laid-Open No. 2009-294134, when all the pixels of measurement data are used for stitch calculation, the calculation load becomes large. For example, assume that an image sensor has a total of 1,000×1,000 pixels, and the overlapping region is 5% of the entire region. In this case, the number of pixels to be used in stitch calculation in measurement data of one partial region is 5,000. Since the minimum number of measurement data which form an overlapping region is two, stitch calculation needs to handle at least 10,000 pixels, and the calculation load becomes large.

### SUMMARY OF THE INVENTION

The present invention provides a technique advantageous for reducing the calculation load necessary to connect (stitch) of measurement data of partial regions in measurement of the shape of a surface to be measured.

According to one aspect of the present invention, there is provided a measurement method of measuring a shape of a surface to be measured having an outer shape of a regular hexagon, including a first step of setting, on the surface to be measured, a plurality of partial regions having an identical outer shape of a parallelogram to cover the entire surface to be measured, a second step of measuring surface shapes of the respective partial regions by a measurement apparatus to obtain measurement data of the respective partial regions, and a third step of connecting the measurement data of the respective partial regions to calculate the shape of the surface to be measured, wherein the parallelogram has internal angles of 120° and 60°, and a maximum length of one side is not larger than a length of one side of the regular hexagon.

Further aspects of the present invention will become apparent from the following description of exemplary embodiments with reference to the attached drawings.

### BRIEF DESCRIPTION OF THE DRAWINGS

FIG. 1 is a view showing the arrangement of a measurement apparatus.

FIG. 2 is a flowchart for explaining a measurement method according to an aspect of the present invention.

FIG. 3 is a view for explaining an example of a plurality of partial regions set on a surface to be measured.

FIG. 4 is a flowchart for explaining in detail processing of step S206 (calculation of the shape of a surface to be measured) shown in FIG. 2.

FIG. 5 is a view for explaining an example of a plurality of partial regions set on a surface to be measured.

FIGS. 6A and 6B are views for explaining an example of a plurality of partial regions set on a surface to be measured.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

A measurement method according to an aspect of the present invention is a method of measuring the surface shape of a surface to be measured having the outer shape of a regular hexagon. This measurement method is suitable to measure the surface shape of a segment mirror which forms the primary mirror of a large astronomical telescope, that is, the surface shape of a mirror having the outer shape of a hexagon with an inscribed circle diameter of more than 1 m.

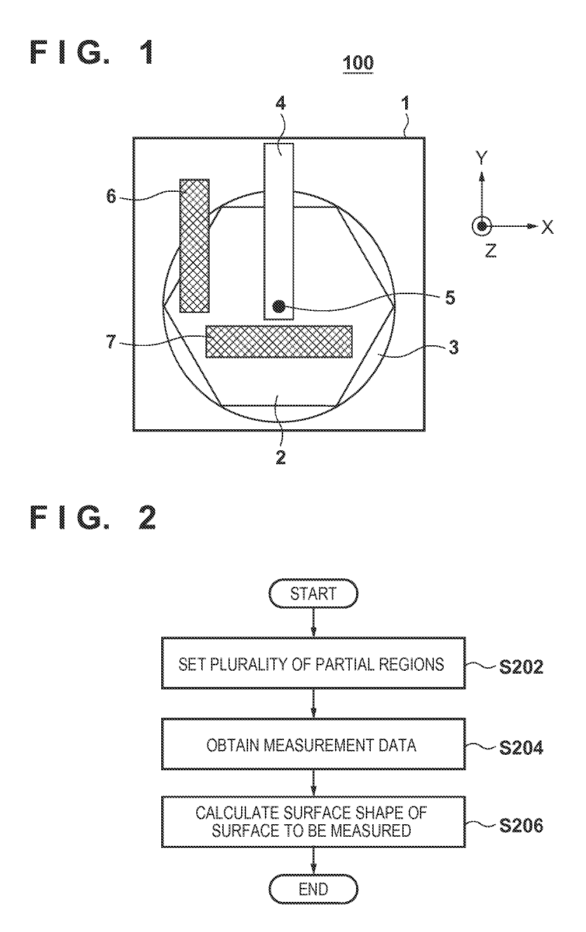

FIG. 1 is a view showing the arrangement of a measurement apparatus 100 used in the measurement method according to the embodiment. The measurement apparatus 100 is a 3D measurement apparatus for measuring a surface 2 to be measured having the outer shape of a regular hexagon. A surface plate 1 is connected to, for example, three vibration dampers (not shown) to prevent the influence of vibrations from the floor on measurement of the surface 2 to be measured. The surface 2 to be measured is held on a rotating stage 3 placed on the surface plate 1. A measurement arm 4 displaceable along the X-, Y-, and Z-axes includes a contact or noncontact probe 5 for measuring the surface shape of the surface 2 to be measured. By rotating the rotating stage 3 to displace the measurement arm 4 along the X-, Y-, and Z-axes, (the surface shape of) each of a plurality of partial regions set on the surface 2 to be measured can be measured, which will be described later. Measurement data (that is, measurement data of each partial region) in the measurement apparatus 100 is obtained as 3D coordinate data (3D position coordinates) of the probe 5. As for the 3D position coordinates of the probe 5, the X-coordinate is obtained using an X-axis reference mirror 6 as a reference, the Y-coordinate is obtained using a Y-axis reference mirror 7 as a reference, and the Z-coordinate is obtained using a Z-axis reference mirror (not shown) as a reference.

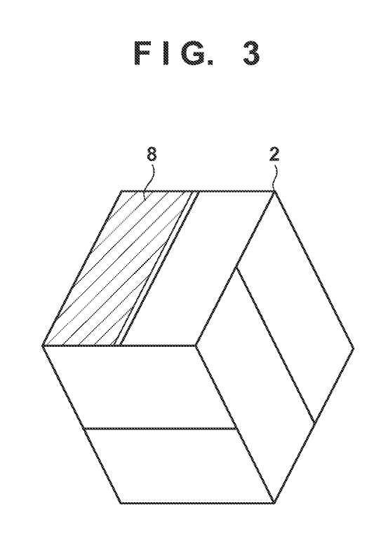

Overall processing of the measurement method according to an aspect of the present invention will be explained with reference to FIG. 2. In step S202, a plurality of partial regions are set on the surface 2 to be measured to cover the entire surface 2 to be measured. In the embodiment, as shown in FIG. 3, six partial regions 8 having the same outer shape of a parallelogram are set on the surface 2 to be measured. Each parallelogramic partial region 8 has internal angles of 120° and 60°, and the maximum length of one side is set to be equal to or smaller than the length of one side of the hexagonal surface 2 to be measured. The number of parallelogramic partial regions 8 is not limited to six, and an arbitrary number of partial regions 8 may be set. The parallelogram includes a square and rhombus. In the embodiment, the six partial regions 8 are set so that adjacent partial regions contact each other, but may be set so that adjacent partial regions overlap each other. Each partial region 8 is set so that its measurement data always reflects internal information (information about the surface shape) of the regular hexagonal surface 2 to be measured, and does not contain NaN (Not a Number) data as much as possible. This is because the presence of NaN data decreases the calculation accuracy for the coefficient of the base of an orthogonal function system which defines a measurement error (system error) when the measurement apparatus 100 measures the shape of each partial region 8, which will be described later.

In step S204, the measurement apparatus 100 measures the respective partial regions 8 set in step S202, obtaining measurement data of the respective partial regions 8. The measurement data obtained in step S204 generally contain measurement errors (system errors) arising from the measurement apparatus 100. The system errors include system errors such as an error unique to the measurement apparatus 100, and errors of the relative positions and orientations of the measurement apparatus 100 and partial regions 8 when measuring the surface shapes of the respective partial regions 8.

In step S206, the measurement data of the respective partial regions 8 that have been obtained in step S204 are connected (stitched), calculating the surface shape of the surface 2 to be measured.

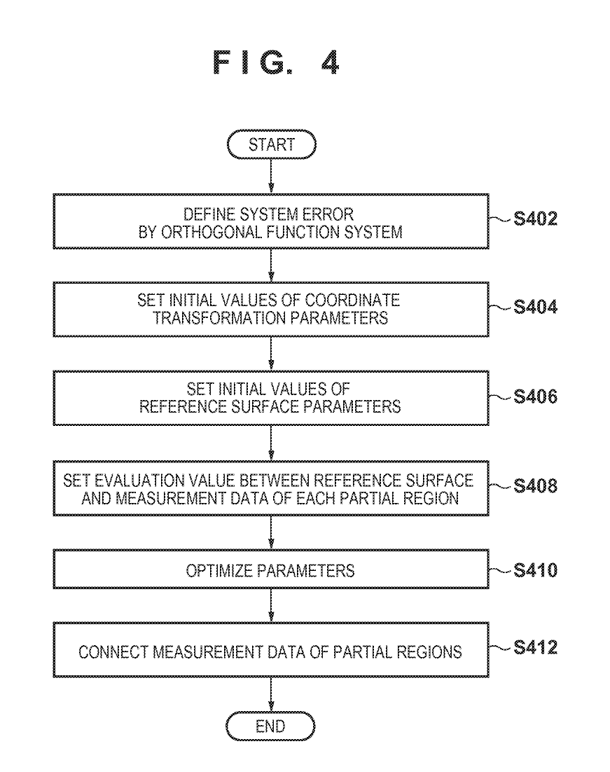

Processing of calculating the shape of the surface 2 to be measured (step S206) will be explained in detail with reference to FIG. 4. In step S402, a system error generated when the measurement apparatus 100 measures the shapes of the partial regions 8 is defined by an orthogonal function system for the respective parallelogramic partial regions 8 set in step S202. In other words, the initial values of system error parameters a₁, a₂, . . . , aₙ are set. In the embodiment, the bases P₁, P₂, . . . , Pₙ of the orthogonal function system are determined using a Gram-Schmidt orthogonalization method for the parallelogramic partial region 8. In this case, the system error P of the respective partial regions 8 is given by

P=a₁P₁+a₂P₂+ . . . +aₙPₙ (1)

where a₁, a₂, . . . , aₙ are the coefficients (variables) of the bases P₁, P₂, . . . , Pₙ. In the embodiment, the outer shapes of all the partial regions 8 are the same parallelogram, so the bases of the same orthogonal function system are usable when calculating a system error using all measurement data. Using the coefficients of the respective bases, instead of the pixels (pixel data) of measurement data, can greatly decrease the number of parameters necessary to calculate a system error, reducing the calculation load. Note that appropriate values are set as the initial values of a₁, a₂, . . . , aₙ at the beginning, but change in optimization.

In step S404, the initial values of coordinate transformation parameters X₁, X₂, . . . , X₆, Y₁, Y₂, . . . , Y₆, Z₁, Z₂, . . . , Z₆, θX₁, θX₂, . . . , θX₆, θY₁, θY₂, . . . , θY₆, and θZ₁, θZ₂, . . . , θZ₆ are set for the respective partial regions 8. The coordinate transformation parameters are the space coordinates of measurement data of the partial regions 8 when stitching measurement data of the partial regions 8 to calculate (composite) the surface shape of the surface 2 to be measured. When the six parallelogramic partial regions 8 are set, measurement data of each partial region 8 has six degrees of freedom (X eccentricity, Y eccentricity, Z eccentricity, rotation about the X-axis, rotation about the Y-axis, and rotation about the Z-axis). In the embodiment, therefore, 36 coordinate transformation parameters are used for stitching. Note that appropriate values are set as the initial values of the coordinate transformation parameters at the beginning, but change in optimization.

In step S406, the initial values of reference surface parameters are set. The reference surface is a virtual surface expressed by an orthogonal function or pixels used when stitching measurement data of the partial regions 8. The size (shape) of the reference surface desirably coincides with the size of the surface 2 to be measured, but may be larger than that of the surface 2 to be measured. When the size of the reference surface is smaller than that of the surface 2 to be measured, all measurement data of the partial regions 8 cannot be used, decreasing the stitch accuracy.

In step S408, an evaluation value (objective function) is set between the reference surface and measurement data of each partial region 8. Letting P be the system error of each partial region 8, D be measurement data of the partial region 8, and R be the reference surface, an evaluation value Q can be given by

Q=R−Σ₆(D−P) (2)

In equation (2), the outer shapes of D and P are parallelograms, so the bases of their orthogonal function systems coincide with each other. Σ represents that a hexagon is formed using six parallelograms of the same shape. The outer shape of R is a hexagon and has bases of an orthogonal function system different from D and P (that is, orthogonal function system different from those of D and P). When comparing orthogonal function systems different from each other, measurement data may be temporarily converted into pixels to obtain a difference for each pixel. Alternatively, the correspondence between the orthogonal function system of the parallelogram and that of the hexagon may be calculated, and the coefficients of the bases of the orthogonal function system for the parallelogram may be converted into those of the bases of the orthogonal function system for the hexagon based on the correspondence to obtain coefficient differences. Similarly, the coefficients of the bases of the orthogonal function system for the hexagon may be converted into those of the bases of the orthogonal function system for the parallelogram based on the correspondence to obtain coefficient differences. In any case, the calculation load can be reduced by obtaining a difference for the coefficient of each base of the orthogonal function system instead of obtaining a difference for each pixel. As described above, the evaluation value Q is obtained by, for example, the sum of squares of differences for respective pixels, or differences for the coefficients of the respective bases of the orthogonal function system.

In step S410, the parameters (variables) are optimized to make the evaluation value (objective function) set in step S408 fall within the allowable range, that is, to minimize the evaluation value in the embodiment. The optimization method is, for example, the least squares method. Parameter values which minimize the evaluation value are obtained, determining system error parameters, coordinate transformation parameters, and reference surface parameters.

In step S412, the measurement data of the partial regions 8 are connected (composited) using the system error parameters and coordinate transformation parameters optimized (determined) in step S410. More specifically, system errors corresponding to the system error parameters optimized in step S410 are removed from the measurement data of the partial regions 8 that have been obtained in step S204. Then, the measurement data of the partial regions 8 from which the system errors have been removed are fitted in space coordinates corresponding to the coordinate transformation parameters optimized in step S410. As a result, the surface shape of the surface 2 to be measured is calculated.

The measurement method according to the embodiment can reduce the calculation load necessary for stitching. For example, assume that an image sensor which forms the probe 5 (that is, is used to measure a surface shape) has a total of 1,000×1,000 pixels, and the overlapping region is 5% of the entire region. In this case, stitch calculation needs to handle at least 10,000 pixels, as described above. In contrast, the embodiment adopts the coefficients of the bases of an orthogonal function system instead of pixels, and the maximum number of coefficients is about 200. This is because the system error is basically represented by bases having low spatial frequencies, and no high spatial frequency need be used in calculation.

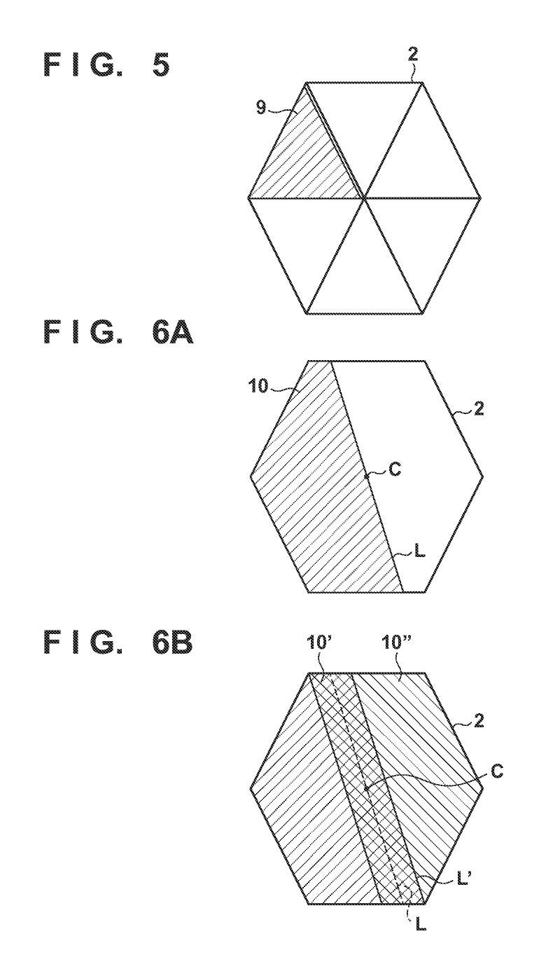

In step S202, six partial regions 9 having the same shape of a triangle may be set on the surface 2 to be measured, as shown in FIG. 5. Each triangular partial region 9 has an internal angle of 60°, and the maximum length of one side is set to be equal to or smaller than the length of one side of the hexagonal surface 2 to be measured. The number of triangular partial regions 9 is not limited to six, and an arbitrary number of partial regions 9 may be set. In FIG. 5, the six partial regions 9 are set so that adjacent partial regions contact each other, but may be set so that adjacent partial regions overlap each other. Each partial region 9 is set so that its measurement data always reflects internal information (information about the surface shape) of the regular hexagonal surface 2 to be measured, and does not contain NaN (Not a Number) data as much as possible.

In step S202, partial regions 10 obtained by dividing the surface 2 to be measured into two by a straight line L passing through the center C of the surface 2 to be measured to have point symmetry may be set on the surface 2 to be measured, as shown in FIG. 6A. When the partial regions are set so that adjacent partial regions contact each other, partial regions 10′ and 10″ may be set on the surface 2 to be measured, as shown in FIG. 6B. The partial region 10′ is a region defined by a straight line L′ obtained by translating the straight line L passing through the center C of the surface 2 to be measured. The partial region 10″ is a region obtained by rotating the partial region 10′ through 180° about the center C.

The outer shape of the measurement region of the measurement apparatus 100 does not always coincide with that of the partial region set in step S202. In general, the size of the measurement region is often larger than that of the partial region (that is, the size of the partial region is set to be smaller than that of the measurement region). In this case, respective partial regions set on the surface 2 to be measured are positioned in the measurement region of the measurement apparatus 100 to measure the measurement region by the measurement apparatus 100, obtaining measurement data containing the surface shapes of the respective partial regions.

Note that the embodiment employs a 3D measurement apparatus as a measurement apparatus for measuring (the shape of) each partial region set on a surface to be measured, but an interferometer may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-229894 filed on Oct. 19, 2011, which is hereby incorporated by reference herein in its entirety.

What is claimed is:

1. A measurement method of measuring a shape of a surface to be measured having an outer shape of a regular hexagon, comprising:
a first step of setting, on the surface to be measured, a plurality of partial regions having an identical outer shape of a parallelogram to cover the entire surface to be measured;
a second step of measuring surface shapes of the respective partial regions by a measurement apparatus to obtain measurement data of the respective partial regions; and
a third step of connecting the measurement data of the respective partial regions to calculate the shape of the surface to be measured,
wherein the parallelogram has internal angles of 120° and 60°, and a maximum length of one side is not larger than a length of one side of the regular hexagon.

2. The method according to claim 1, wherein the third step includes steps of:
for each of the partial regions, defining, by an orthogonal function system, a measurement error generated when the measurement apparatus measures a surface shape of the partial region;
setting an objective function including a coefficient of the orthogonal function system as a variable for each of the partial regions, determining the coefficient to make a value of the objective function fall within an allowable range, and obtaining the measurement error; and
connecting the measurement data of the respective partial regions from which the measurement error has been removed, and calculating the shape of the surface to be measured.

3. A measurement method of measuring a shape of a surface to be measured having an outer shape of a regular hexagon, comprising:
a first step of setting, on the surface to be measured, a plurality of partial regions having an identical outer shape of a triangle to cover the entire surface to be measured;
a second step of measuring surface shapes of the respective partial regions by a measurement apparatus to obtain measurement data of the respective partial regions; and
a third step of connecting the measurement data of the respective partial regions to calculate the shape of the surface to be measured,
wherein the triangle has an internal angle of 60°, and a maximum length of one side is not larger than a length of one side of the regular hexagon.

4. The method according to claim 3, wherein the third step includes steps of:
for each of the partial regions, defining, by an orthogonal function system, a measurement error generated when the measurement apparatus measures a surface shape of the partial region;
setting an objective function including a coefficient of the orthogonal function system as a variable for each of the partial regions, determining the coefficient to make a value of the objective function fall within an allowable range, and obtaining the measurement error; and
connecting the measurement data of the respective partial regions from which the measurement error has been removed, and calculating the shape of the surface to be measured.

5. A measurement method of measuring a shape of a surface to be measured having an outer shape of a regular hexagon, comprising:
a first step of setting, on the surface to be measured, partial regions obtained by dividing the surface to be measured by a straight line passing through a center of the surface to be measured to have point symmetry;
a second step of measuring surface shapes of the respective partial regions by a measurement apparatus to obtain measurement data of the respective partial regions; and
a third step of connecting the measurement data of the respective partial regions to calculate the shape of the surface to be measured.

6. The method according to claim 5, wherein the third step includes steps of:
for each of the partial regions, defining, by an orthogonal function system, a measurement error generated when the measurement apparatus measures a surface shape of the partial region;
setting an objective function including a coefficient of the orthogonal function system as a variable for each of the partial regions, determining the coefficient to make a value of the objective function fall within an allowable range, and obtaining the measurement error; and
connecting the measurement data of the respective partial regions from which the measurement error has been removed, and calculating the shape of the surface to be measured.

7. A measurement method of measuring a shape of a surface to be measured having an outer shape of a regular hexagon, comprising:
a first step of setting, on the surface to be measured, a plurality of partial regions having an identical outer shape of a parallelogram to cover the entire surface to be measured;
a second step of positioning the respective partial regions in a measurement region of the measurement apparatus, performing measurement by the measurement apparatus, and obtaining measurement data containing surface shapes of the respective partial regions for the respective partial regions; and
a third step of connecting the measurement data to calculate the shape of the surface to be measured,
wherein the parallelogram has internal angles of 120° and 60°, and a maximum length of one side is not larger than a length of one side of the regular hexagon.

8. The method according to claim 7, wherein a size of the measurement region is larger than a size of the partial region.
